(19) United States
(12) Patent Application Publication
(10) Pub. No.: US 2026/0018830 A1
(43) Pub. Date: Jan. 15, 2026

(54) Electrical Connector

(71) Applicant: Klein Tools, Inc., Lincolnshire, IL (US)

(72) Inventors: James E. Murphy, Bartonville, TX (US); Brian Frank, Fort Worth, TX (US); James Schroeder, Aurora, IL (US); Danial Wolniak, Almont, MI (US)

(73) Assignee: Klein Tools, Inc., Lincolnshire, IL (US)

(21) Appl. No.: 19/240,650

(22) Filed: Jun. 17, 2025

Related U.S. Application Data
(60) Provisional application No. 63/661,566, filed on Jun. 18, 2024.

(51) Int. Cl. H01R 13/629

(52) U.S. Cl. CPC H01R 13/62966

(57) ABSTRACT

An electrical connector is provided for electrically connecting a pair of conductors and includes: a housing made of an electrical insulating material, the housing having a pair of conductor insertion openings; a busbar component mounted in the housing between the insertion openings; a pair of cantilevered contact arms, each arm positioned on a side of the busbar opposite from the other contact arm to clamp a conductor against the busbar; and a pair of actuating member, each of the actuating members mounted on opposite sides of the busbar to actuate a corresponding one of the contact arms from an initial position to an inserting position as the actuating member is moved from a closed position to an open position.

### CROSS-REFERENCE TO RELATED APPLICATIONS

This application claims priority to U.S. provisional application Ser. No. 63/661,566, titled Electrical Connector, filed Jun. 18, 2024, the entire disclosure of which is incorporated herein by reference.

### BACKGROUND OF THE DISCLOSURE

The present disclosure relates to electrical connectors including, without limitation, terminal connectors.

Electrical connectors, including terminal connectors having a release lever or actuator are known and typically have release levers that are pivot mounted in a housing made from an electrically insulating material. The release levers typically engage some form of spring biased clamp that forms an electrical connection between a busbar mounted in the housing and an electrical conductor inserted into the housing. Often there are multiple such release levers and spring biased clamps in a single housing for forming an electrical connection between several electrical conductors inserted into the housing and the busbar. Such electrical connectors are often referred to a release or lock lever quick connectors. While such known electrical connectors may be suitable for their intended use, there is always room for improvement.

### BRIEF SUMMARY OF THE DISCLOSURE

In accordance with this disclosure, embodiments of an electrical connector are disclosed and can provide the following features and benefits.

### Compact Stacked Design

The disclosed embodiments provide a compact, low-profile ‘bullet’ design shape that is similar to the time-tested twist-on form of traditional wire connectors, making it ideal for fitting into tight electrical boxes. The stacked multi-port configuration emphasizes compactness compared to conventional in-line release lever quick connectors while providing a familiar, confident, twist-on style appearance, feel, and user experience.

### Ergonomic Reversed Lever Actuation

Several of the disclosed embodiments provide a unique reversed action levers are operated from the opposite end of the connector from where the wiring is inserted, providing a two-handed operation like a traditional twist-on wire nut. One hand manages the wiring while the other actuates the levers of the connector, ensuring a secure and positive connection as the lever moves from open to closed. This prevents the connector from being coaxed off during actuation. Additionally, levers are contoured towards the pointed end of the bullet shape, which allows the forces applied while squeezing the connector into tight boxes to push the levers closed, rather than encouraging them to pop open.

### Versatile Housing for Visibility & Testing

All of the disclosed embodiments can include clear, translucent housing body that allows a user to confidently view the conductors through the housing, even in dimly lit environments, for visual confirmation of correct seating of the conductors before actuating a lever from an open to a closed position. The housings can also include a test port, allowing for continuity or voltage measurements using standard multimeters and leads.

### Accommodates Wide Range of Wire Sizes

All of the disclosed embodiments are, in their preferred and disclosed forms, configured to accommodate both solid and stranded wires ranging from 24 AWG to 12 AWG, covering the most common wire gauges utilized by electricians in lighting and building applications.

The following are examples of features/structures that could be claimed based on the disclosed embodiments:
Claim 1. An electrical connector for electrically connecting a pair of conductors, the electrical connector comprising:
housing made of an electrical insulating material, the housing having a pair of conductor insertion openings, each of the insertion openings configured to allow one of the pair of conductors to be inserted into the housing;
a pair of spring contact units mounted within the housing, each of the spring contact units located relative to a corresponding one of the insertion openings to engage one of the pair of conductors inserted through the one of the insertion openings, each of the spring contact units comprising:
a contact surface,
an opposite surface spaced from the contact surface,
a connecting surface extending between the contact surface and the opposite surface, and
a cantilevered contact arm extending between the pair of surfaces to clamp a conductor against one of the pair of surfaces, the contact arm having a contact portion to engage a conductor inserted between the contact portion and the contact surface, the contact arm movable between an initial position wherein a conductor of a predetermined size cannot be freely inserted between the contact portion and the contact surface and an inserting position wherein the conductor of a predetermined size can be freely inserted between the contact portion and the contact surface, the contact arm being spring biased to the initial position;
a pair of actuating member, each of the actuating members mounted in a corresponding one of the spring contact units to actuate the contact arm from the initial position to the inserting position as the actuating member is moved from a closed position to an open position, each of the actuating members comprising:
an arm engagement surface engaged with the contact arm to transmit an actuation force to the contact arm to move the contact arm from the initial position to the inserting position as the actuating member is moved from the closed position to the open position,
a first guide surface slidably engaged with the contact surface and the connecting surface to assist in guiding the actuating member to translate and rotate as the actuating member moves between the closed and open positions,
a second guide surface slidably engage with the opposite surface to assist in guiding the actuating member to translate and rotate as the actuating member moves between the closed and open positions, and
a user lever fixed to the arm contact, first guide surface, and second guide surface to transmit the actuation force from a user to the contact arm as a user moves the actuating member from the closed position to the open position.

The electrical connector of claim 1 wherein:
the contact surfaces are defined by a busbar component mounted in the housing between the insertion openings;
the opposite surfaces and the connecting surfaces are defined by a u-shaped component having a connecting spine extending perpendicular to the busbar component and a pair of legs extending from the connecting spine on opposite sides of the busbar component from each other;
each of the contact arms arm extends from a corresponding one of the pair of legs, with the contact portions abutted against the corresponding contact surface of the busbar with the contact arm in the initial position.

The electrical connector of claim 2 wherein the u-shaped component and the contact arms are all made of an electrically conductive material.

The electrical connector of claim 1 wherein:
each of the first guide surfaces comprises a first curved surface and a first flat surface;
each of the second guide surfaces comprises a second curved surface;
each of the arm engagement surfaces comprises a third curved surface that extends from a corresponding one of the first curved surfaces.
The electrical connector of claim 1 wherein the first and second guide surfaces of each actuating member are configured to resist movement of the actuating member from the open position via engagement with the contact surface and opposite surface.

The electrical connector of claim 1 wherein the spring unit is made of electrically conductive material.

An electrical connector for electrically connecting a pair of conductors, the electrical connector comprising:
housing made of an electrical insulating material, the housing having a pair of conductor insertion openings, each of the insertion openings configured to allow one of the pair of conductors to be inserted into the housing;
a busbar component mounted in the housing between the insertion openings;
a pair of cantilevered contact arms, each arm positioned on a side of the busbar opposite from the other contact arm to clamp a conductor against the busbar, each contact arm having a contact portion to engage a conductor inserted between the contact portion and the busbar, the contact arm movable between an initial position wherein a conductor of a predetermined size cannot be freely inserted between the contact portion and the busbar and an inserting position wherein the conductor of a predetermined size can be freely inserted between the contact portion and the busbar, the contact arm being spring biased to the initial position; and
a pair of actuating member, each of the actuating members mounted on opposite sides of the busbar to actuate a corresponding one of the contact arms from the initial position to the inserting position as the actuating member is moved from a closed position to an open position.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view an electrical connector according to this disclosure for connecting the conductors of two electrical wires;

FIG. 2 is a perspective view of the electrical connector of claim 1 but showing a clear or transparent housing component that allows an observer to see the components contained within the housing component and a contact arm component on the left side not being shown for purposes of illustration;

FIG. 3 is a perspective view of an electrical connector that is similar to the connector of FIGS. 1 and 2, but modified to connect the conductors of three electrical wires;

FIG. 4 is an exploded perspective view of the components of the connector of FIG. 3;

FIG. 5 is a side view of the electrical connector of FIGS. 1 and 2, but showing the housing components as clear or transparent and showing an actuating lever on the right side of the connector in a closed position with a contact arm on the right side of the connector shown in an initial position and an actuating lever on the left side of the connector in an intermediate position with a contact arm on the left side of the connector in an actuated position;

FIG. 6 is a view similar to FIG. 5, but showing the actuating lever on the left side of the connector in an open position and the contact arm on the left side of the connector in a conductor inserting position and the actuating lever on the right side in the closed position and the contact arm on the right side in a clamping position, with a conductor shown in phantom in a fully inserted position on the left side and another conductor shown in a fully inserted and clamped condition on the right side;

FIG. 7 is a perspective view of the connector of FIG. 5, but with a lower housing component shown as being opaque;

FIG. 8 is a perspective view of the connector of FIG. 6, but with the lower housing component again shown as being opaque and no conductors shown in phantom;

FIGS. 9 and 10 are perspective views of selected components of the connectors of FIGS. 1, 2, and 5-8, with an actuating lever shown in a closed position and a contact arm shown in an initial position like that of right-hand lever in FIGS. 5-8;

FIG. 11 is another perspective view of the components of FIGS. 9 and 10, but showing the lever moved from the closed position to an intermediate position;

FIG. 12 is a side view of the components of FIGS. 9-11, but showing the lever in the open position and the contact arm in the inserting position shown on the left-hand side of FIGS. 6 and 8, with a conductor of a wire inserted into a connected position;

FIG. 13 is a perspective view of the component of FIGS. 9-12, but with both levers shown and both contact arms shown, and with the levers shown in the closed position and the contact arms shown in the initial position;

FIG. 14 is a perspective view of selected components of FIG. 13, with contact arms shown in the initial position;

FIG. 15 is a perspective view of the connector of FIGS. 1-2 and 5-9;

FIG. 16 is a top plan view of the connector of FIG. 15;

FIG. 17 is a left-side elevation of the connector of FIGS. 15 and 16, with the right-side elevation being a mirror image of FIG. 17;

FIG. 18 is a front view of the connector of FIGS. 15-17;

FIG. 19 is a section view taken from line A-A in FIG. 17;

FIG. 20 is a perspective view of the connector of FIGS. 3 and 4;

FIG. 21 is a top plan view of the connector of FIG. 20;

FIG. 22 is a left-side elevation of the connector of FIGS. 20 and 21;

FIG. 23 is a front view of the connector of FIGS. 15-17;

FIG. 24 is a section view taken from line A-A in FIG. 21;

FIGS. 25 and 26 are perspective views of an electrical connector that is similar to the connectors of FIGS. 1-24, but modified to connect the conductors of five electrical wires;

FIGS. 27 and 28 are additional perspective views of the connector of FIGS. 3, 4, and 20-24;

FIGS. 29 and 30 are additional perspective views of the connector of FIGS. 1, 2, 5-8, and 15-19;

FIGS. 31-36 are identical to FIGS. 25-30, but showing the housing components as clear or transparent to allow an observer a better view of the internal components of the connectors;

FIGS. 37-40 are additional perspective views of the connector of FIGS. 3, 4, 20-24, 27, 28, 33, and 34;

FIGS. 41-44 are identical to FIGS. 37-40, but showing the housing components as clear or transparent to allow an observer a better view of the internal components of the connectors;

FIGS. 45 and 46 are additional perspective views of the connector of FIGS. 25 and 26;

FIGS. 47 and 48 are additional perspective views of the connector of FIGS. 1, 2, 5-8, 15-19, 29, 30, 35, and 36;

FIGS. 49 and 50 are additional perspective views of the connector of FIGS. 26, 26, 45, and 46;

FIG. 51 is a top plan view of the connector of FIGS. 49 and 50;

FIG. 52 is a left side view of the connector of FIGS. 49-51;

FIG. 53 is a front view of the connector of FIGS. 49-52;

FIG. 54 is an exploded view of the components of the connector of FIGS. 49-52;

FIG. 55 is identical to FIG. 54, but shown enlarged;

FIG. 56 is a perspective view of an electrical connector that is similar to the connectors of FIGS. 1-55, but modified to connect the conductors of four electrical wires;

FIG. 57 is a top plan view of the connector of FIG. 56;

FIG. 58 is a left side elevation of the connector of FIGS. 56 and 57; and

FIG. 59 is a front view of the connector of FIGS. 56-58.

### DETAILED DESCRIPTION OF PREFERRED EMBODIMENTS

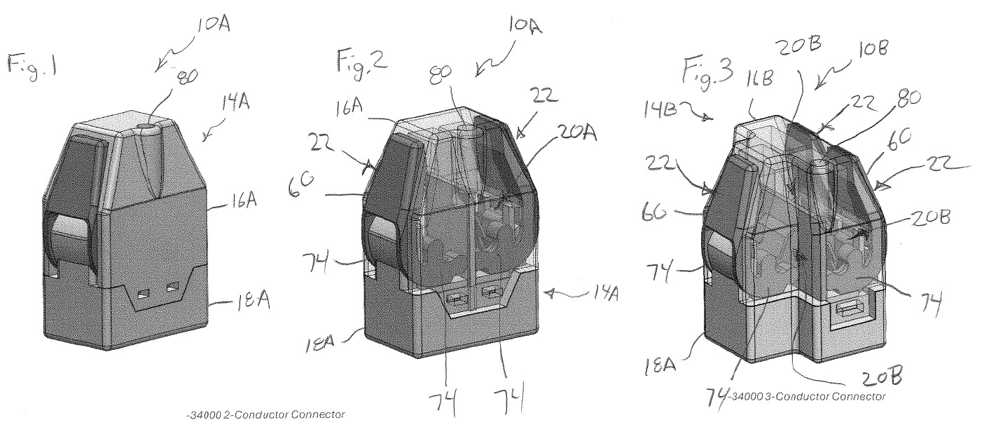

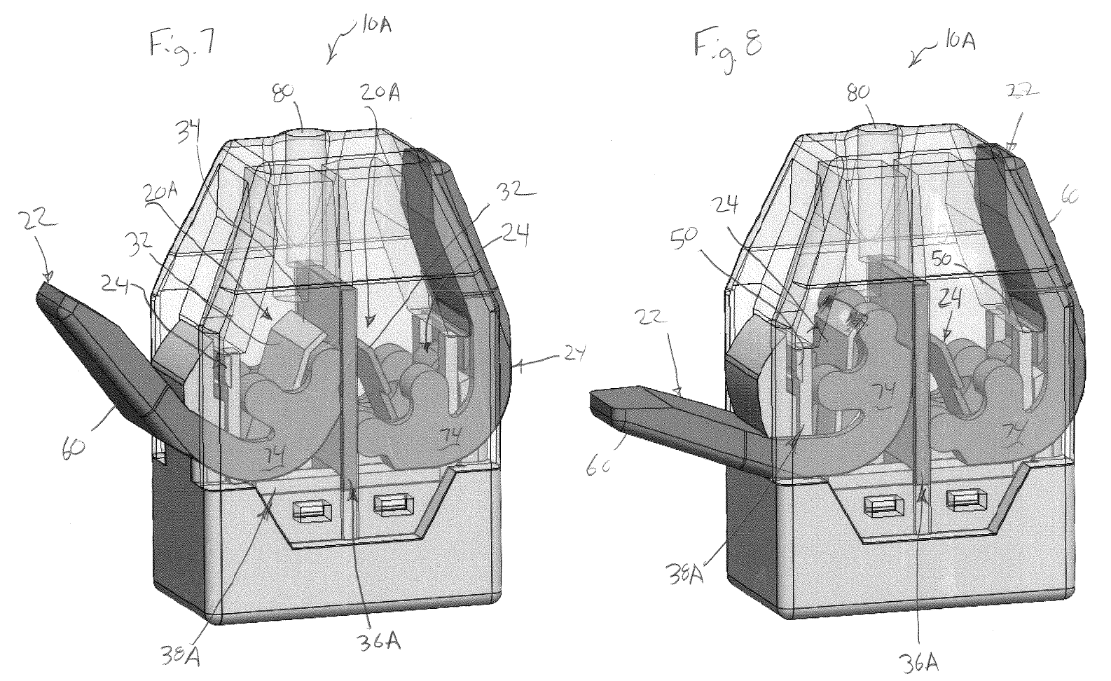

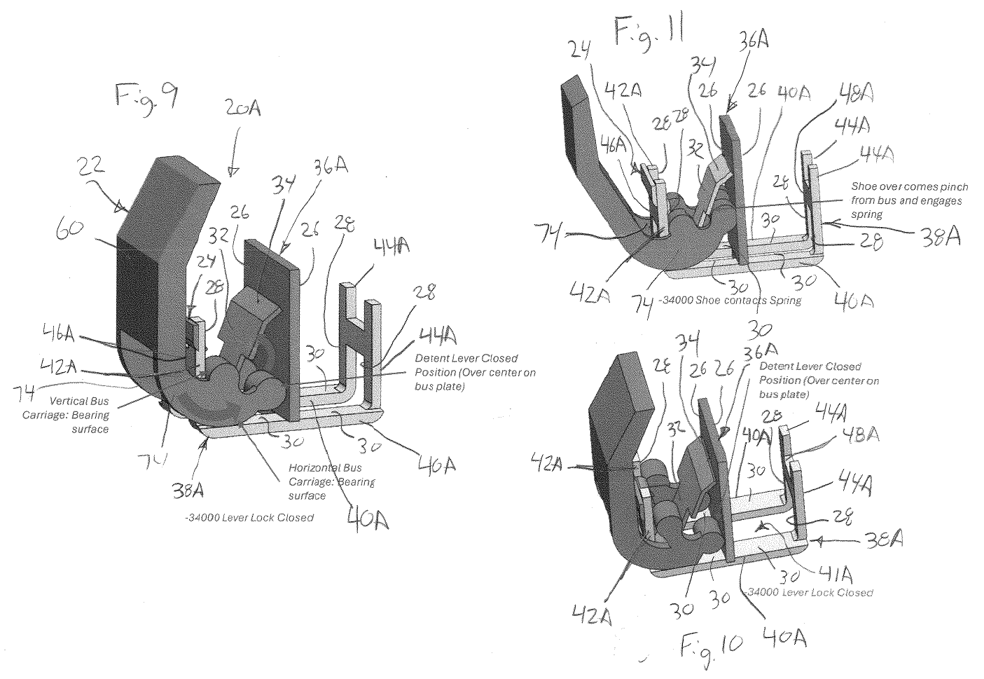

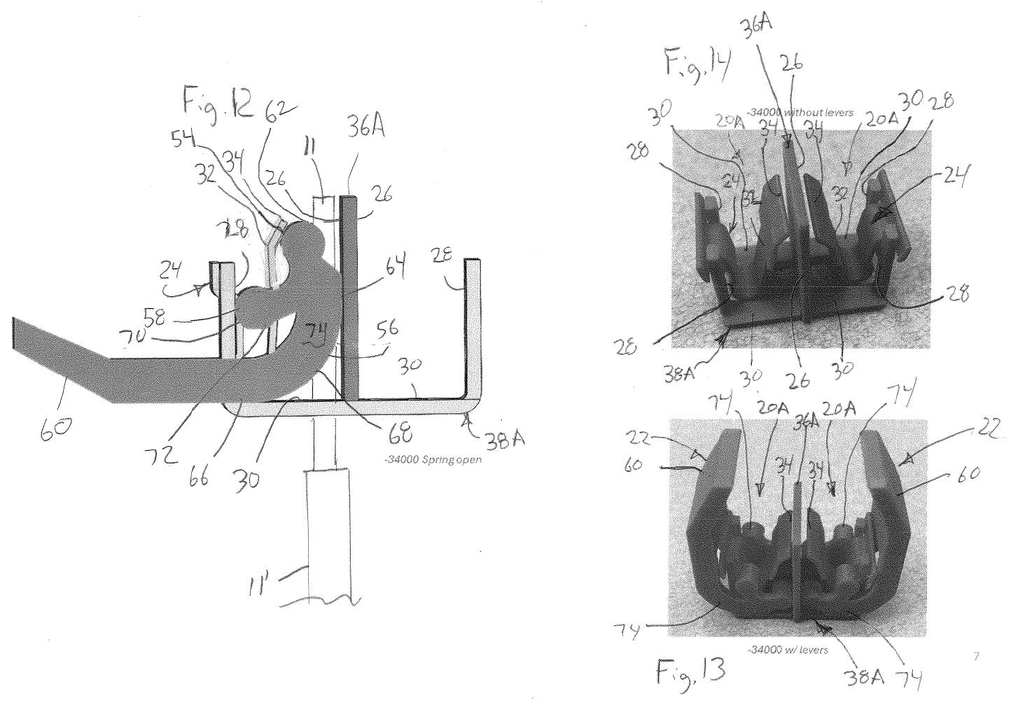

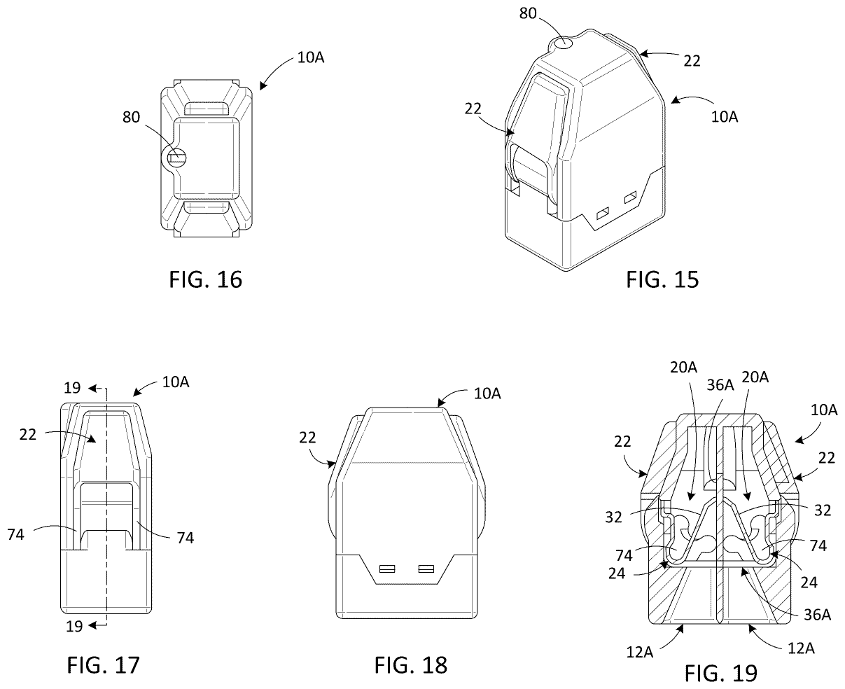

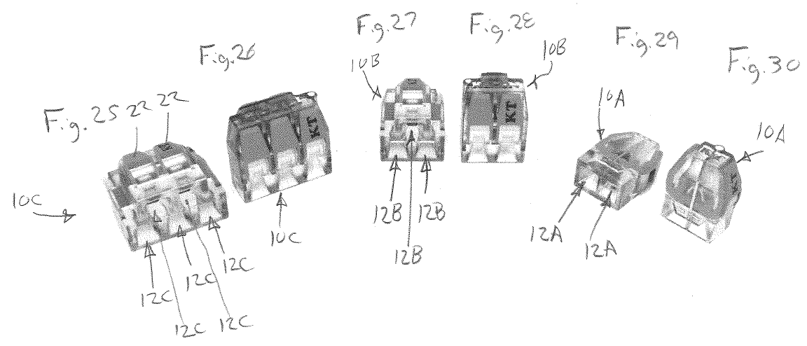

As best seen in FIGS. 1, 2 and 5-19, 29, 30, 35 and 36, an electrical connector 10A is shown for connecting the electrical conductors 11 of two electrical wires 11′. As best seen in FIGS. 5, 6, 19, and 29, the connector 10A includes two conductor insertion openings or ports 12A, with each conductor port 12A being adapted to receive the electrical conductor of a single electrical wire. The connector 10A further includes a housing 14A made from an electrical insulating material, with housing 14A being an assembly of an upper housing component 16A and a lower housing component 18A, with each of the components 16A and 18A being made from an electrical insulating material. In the illustrated and preferred embodiments, the ports 12A are formed in the lower housing component 18A. As best seen in FIGS. 5-8, the connector 10A further includes a pair of spring clamp or contact units, shown generally at 20A, with each unit 20A being aligned with a corresponding one of the conductor ports 12A. As again best seen in FIGS. 5-8, the connector 10A further includes a pair of actuating members or levers 22, with each lever 22 being mounted in a corresponding one of the spring contact units 20A.

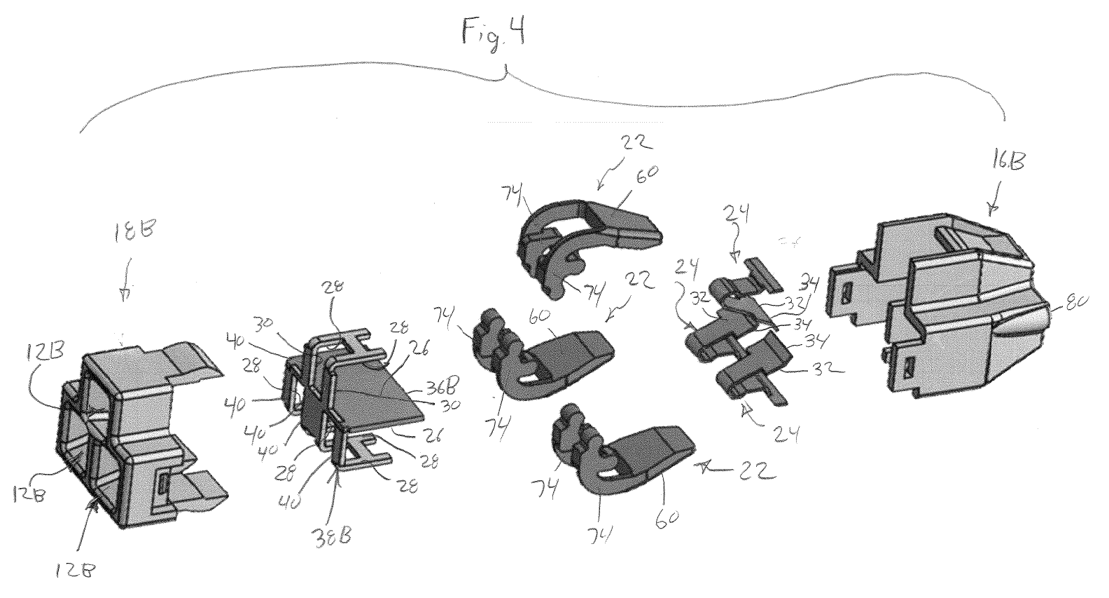

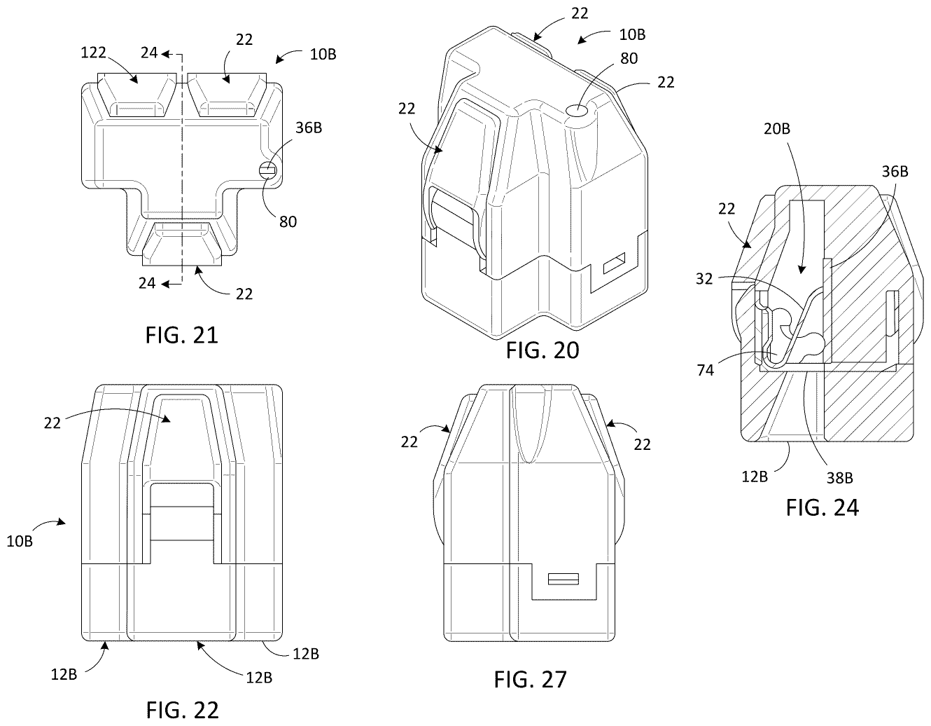

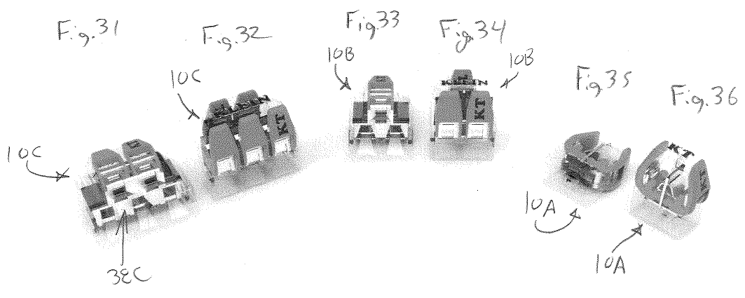

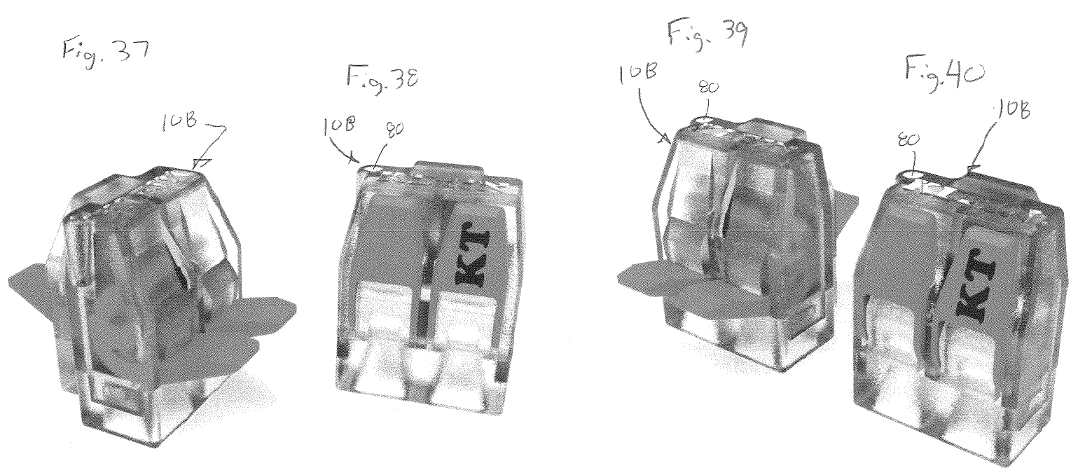

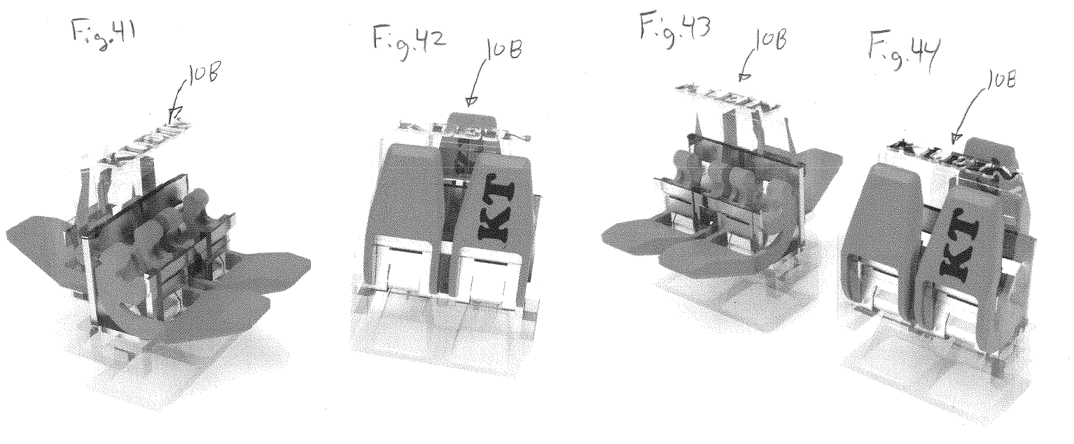

As best seen in FIGS. 3, 4, and 21-24, 27, 28, 33, and 34 an electrical connector 10B is shown for connecting the electrical conductors 11 of three electrical wires 11′. As best seen in FIGS. 4, 27, and 33, the connector 10B includes three conductor insertion openings or ports 12B, with each conductor port 12B being adapted to receive the electrical conductor of a single electrical wire. The connector 10B further includes a housing 14B made from an electrical insulating material, with housing 14B being an assembly of an upper housing component 16B and a lower housing component 18B, with each of the components 16b and 18B being made from an electrical insulating material. In the illustrated and preferred embodiment, the ports 12B are formed in the lower housing component 18B. As best seen in FIGS. 3, 4, and 24, the connector 10B further includes a three spring clamp or contact units, shown generally at 20B, with each unit 20B being aligned with a corresponding one of the conductor ports 12B. As best seen in FIGS. 3, 4, and 20-24, the connector 10B further includes three actuating members or levers 22, with each lever 22 being mounted in a corresponding one of the spring contact units 20B.

It can be seen, that in the preferred embodiments, all of the levers 22 are identical to each other and are a common component shared by both of the connectors 10A and 10B. It should further be understood, that in the preferred embodiments, all of the spring clamp or contact units 20A and 20B function in the identical manner, and with each of the units 20A and 20B including a spring contact arm component 24 that is common to all of the units 20A and 20B, with all of the spring contact arm components 24 being identical to each other. Preferably the spring contact arm components are made from a suitable spring material, such a suitable spring steel, that is also electrically conductive.

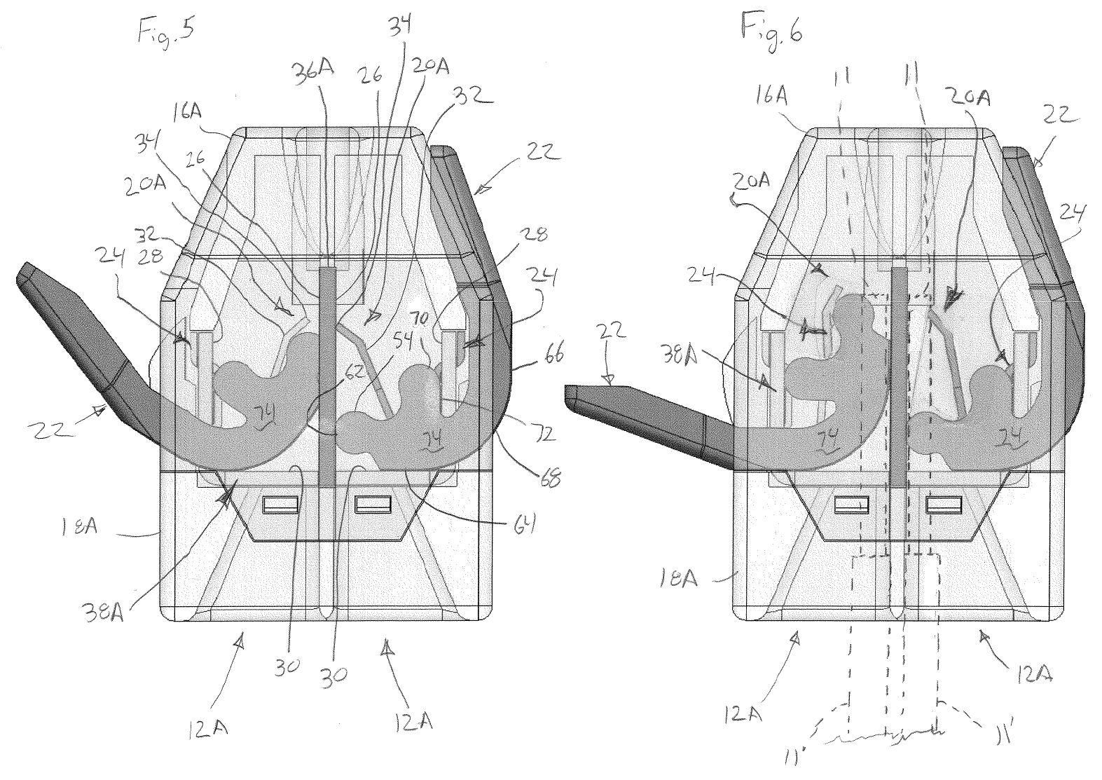

As best seen in FIGS. 5-14, in the preferred embodiments, each of the spring contact units 20A includes a contact surface 26, a pair of opposite surfaces 28 that are spaced from and parallel to the contact surface 26, and a pair of connecting surfaces 30 that extend from the contact surface 26 to a corresponding one of the opposite surfaces 28 and are perpendicular to the surfaces 26 and 28. It should be understood that while it is preferred that each of the spring contact units 20A include two of the surfaces 28 and two of the surfaces 30, in some applications it may be desirable to have only one opposite surface 28 and/or only one connecting surface 30. Each of the spring contact units 20A further includes a cantilevered contact arm 32 defined by one of the spring contact arm components 24, with each of the contact arms having a contact portion 34 to engage or clamp a conductor 11 inserted between the contact portion 34 and the contact surface 26, as best seen on the right side of FIG. 6. Each contact arm 32 is movable, via deflection of the spring contact arm component 24, between an initial position (shown on the right side of FIGS. 5 and 7 and on both sides in FIGS. 13 and 14) wherein a conductor 11 of a predetermined size or range of sizes, and preferably of any size, cannot be freely inserted between the contact portion 34 and the contact surface 26 and an inserting position (shown left side of FIGS. 6, 8, and 12) wherein the conductor 11 of a predetermined size or range of sizes can be freely inserted between the contact portion 34 and the contact surface 26, with the contact arm 32 being spring biased to the initial position by the spring force of the spring contact arm component 24. Preferably, the contact portion 34 is abutted against the contact surface 26 in the initial position.

As best seen in FIGS. 5-14, for each of the spring contact units 20A, the contact surfaces 26 are preferably defined by opposite faces of a busbar component 36A that is held in the housing 14A. The opposite surfaces 28 and the connecting surfaces 30 are preferably defined by a U-shaped component 38A mounted in the housing 14A and having an electrically conductive connection with the busbar component 36A, again as best seen in FIGS. 5-14. In this regard, it should be understood that in the preferred embodiments each of the busbar component 36A and the U-shaped component 38A are formed from a suitable electrically conductive material. As best seen in FIGS. 9-11 and 14, in the preferred embodiment, the U-shaped component 38A has a pair of connecting spines 40A extending perpendicular to the busbar component 36A. Each of the spines 40A define a connecting surface 30 for each of the spring contact units 20A. The spines 40A are spaced from each other to provide a gap or opening 41A through which a conductor can be inserted for engagement between the corresponding contact portion 34 and contact surface 26. The U-shaped component further includes a first pair of legs 42A and a second pair of legs 44A, with each of the legs 42A and 44A extending from a corresponding one of the spines 40A. Each of the legs 42A defines an opposite surface 28 for one of the spring contact units 20A and each of the legs 44A defines an opposite surface 28 for the other spring contact unit 20A. In the preferred embodiment, the U-shaped component 38A further includes a transverse cross member 46A that connects the legs 42A and a transverse cross member 48A that connects the legs 44A. In the preferred embodiment, the spines 40A, legs 42A, legs 44A, cross member 46A and cross member 48A are all formed from a single continuous piece of material, such as, for example, a single piece of sheet metal, with the busbar component 36A being formed from a different piece of material that has been engaged with the U-shaped component 38A, such as via an interference fit, a brazed connection, a welded connection, or a bonded connection. In some embodiments, it may be advantageous to form the busbar component 38A and the U-shaped component 38A from a single piece of material.

As best seen in FIG. 8, each of the spring contact arm components 24 include a transverse tang 50 that engages against end portions of the legs 42A or 44A that help to retain the spring contact arm components to the U-shaped component 38A. Further in this regard, a portion of each of the spring contact arm components 24 extending form the tang pass across a side of the cross member 46A or 48A opposite from the tang 50 to help react the spring force generated by engagement of the contact portion 34 with the contact surface 26 to further help retain the spring contact arm component to the U-shaped component 38A. It should be understood that the increasing spring force generated by movement of the contact arm 32 from the initial position to the inserting position is also reacted out by the engagement against the corresponding cross member 46A or 48A.

Each of the actuating members or levers 22 is mounted in a corresponding one of the spring contact units 20A top actuate the contact arm 32 from the initial position (shown on the right side of FIGS. 5 and 7 and on both sides in FIGS. 13 and 14) to the inserting position (shown on the left side of FIGS. 6, 8, and 12) as the actuating member is moved from a closed position (shown on the right side of FIGS. 5-7, the left side of FIGS. 9 and 10, and on both sides of FIGS. 1, 2, 13, and 15-19) to an open position (shown on the left side of FIGS. 6, 8, and 12). In the preferred and illustrated embodiments, each of the actuating members includes an arm engagement surface 54, a pair of first guide surface 56, a second guide surface 58 and a user lever portion 60. The arm engagement surface 54 slidably engages with the contact arm 32 to transmit an actuation force to the contact arm 32 to move the contact arm 32 from the initial position to the inserting position as the actuating member 22 is moved from the closed position to the open position. The first guide surface 56 slidably engages the contact surface 26 and the connecting surface 30 to assist in guiding the actuating member 22 to translate and rotate as the actuating member 22 moves between the closed and open positions. The second guide surface 58 slidably engages the opposite surface 28 to assist in guiding the actuating member 22 to translate and rotate as the actuating member 22 moves between the closed and open positions. In the illustrated and preferred embodiment, the arm engagement surface 54 is entirely a curved surface 54; the first engagement surface 56 includes a curved surface 62 that extends from the curved surface 54, a flat surface 64, a flat surface 66 and a curved surface 68 that extends from the flat surface 64 to the flat surface 66; and the second engagement surface 58 includes a curved surface 70 that extends from a flat surface 72. As best seen in FIGS. 7, 8, 10, 11 and 13, in the illustrated and preferred embodiment, each of the actuating members 22 include a pair of feet 74 fixed to and extending from the user lever portion 60, with each of the feet 74 defining a set of the surfaces 54, 56, and 58 such that each actuation member has two sets of the surfaces 54, 56, and 58. While the two sets are preferred, in some cases, one set of the surfaces 54, 56, and 58 defined by a single foot 74 may be desirable. Those skilled in the art will understand that the respective engagement between the first and second guide surfaces 56 and 58 of the actuating member 22 and the contact surface 26 and opposite surface 28 will resist movement of the actuating member 22 from the closed position and from the open position until there is adequate deflection in some or all of the actuating member 22, busbar component 36A, and U-shaped component 38A. Furthermore, it should be appreciated that the actuating member must be translated 22 along the contact surface from the initial position to an intermediate position shown on the left side of FIG. 7 before the arm engagement surface 54 engages the contact arm 32. It should further be appreciated that because of the interactions of the surfaces 54, 56, and 58 with the surfaces 26, 28, and 30 of each spring contact unit 20A, all or most of the forces associated with deleting the contact arm 32 from the initial position to the inserting position are reacted out within the spring contact unit 20A rather than by the housing 14.

As best seen in FIGS. 3, 4, and 20-24, the three spring contact units 20B of the connector 10B each include a spring contact arm component 24 identical to the component described above for the connector 10A, and a busbar component 36B and U-shaped component 38B that provide the surfaces 26, 28, and 30 as described above but modified to accommodate three conductors 11 rather than two. As with the connector 10A, an actuating member 22 (identical to the member 22 describes above for connector 10A) is mounted in each of the spring contact units 20B to actuate each of the contact arms 32 in a fashion identical to that describe above for connector 10A. As seen in FIGS. 3, 4, and 20-24, two of the spring contact units 20B have been arranged in a side-by-side configuration and one of the contact units 20B has been arranged on the opposite side of the busbar 36A halfway between the other two spring contact units 20B. This arrangement provides a compact, bullet shaped configuration.

As seen in FIGS. 1, 2, 3, 4, 7, 8, 15, 16, 20, and 21, the upper housings 16A and 16B are provided with test ports 80 that allow a standard probe to be inserted to contact the busbar components 36 to check for continuity or voltage measurements.

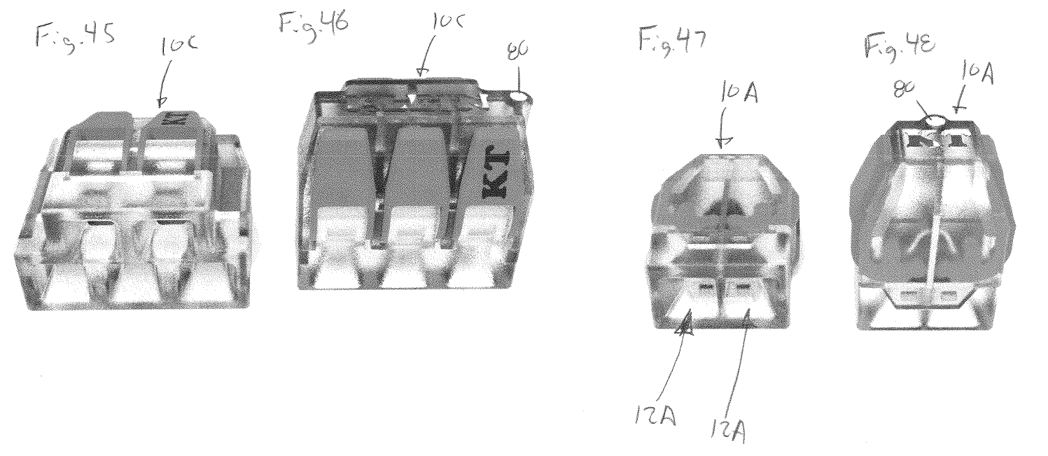

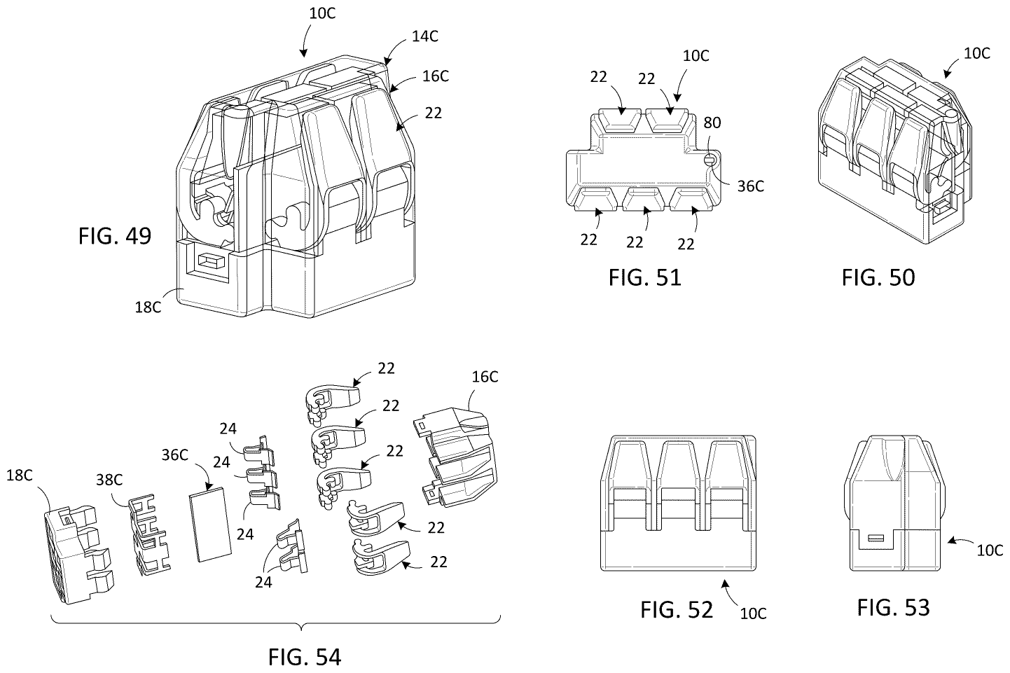

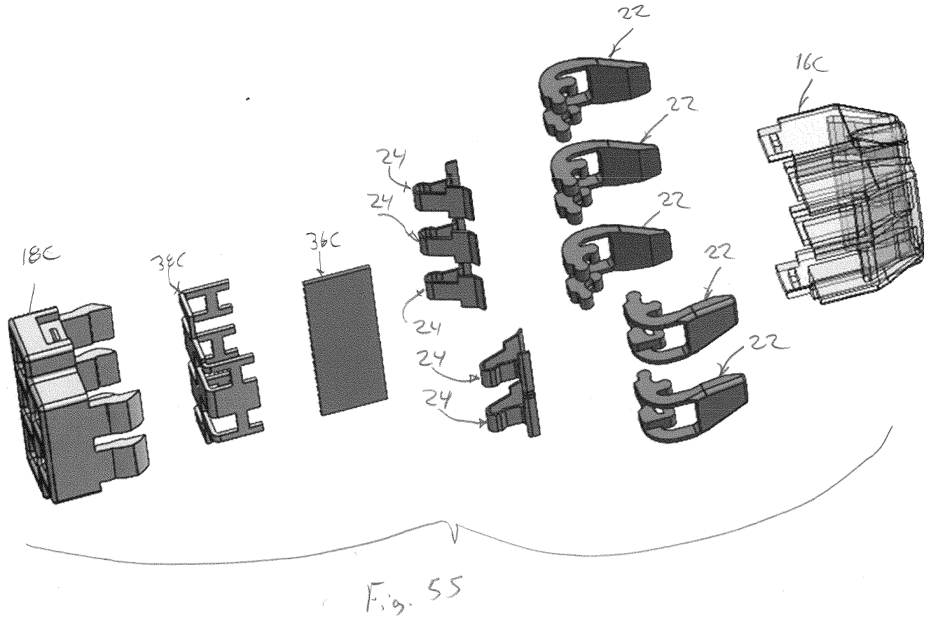

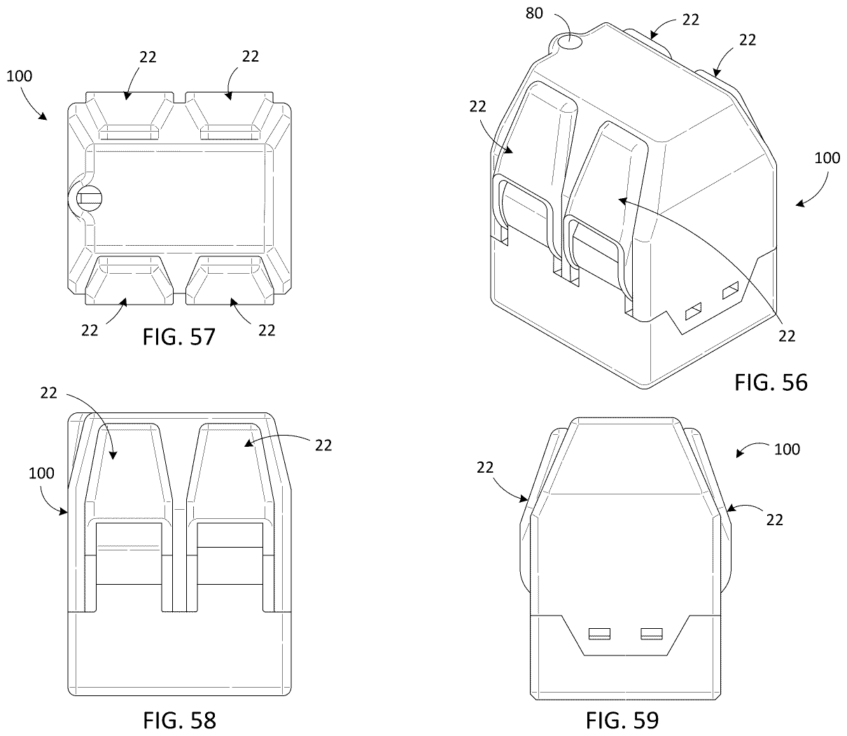

As seen in FIGS. 25, 26, 31, 32, 45, 46, and 49-54, an electrical connector 10C for connecting the electrical conductors 11 of five electrical wires 11′ can be created by modifying the connector 10B to include two additional ports 12, two additional spring contact units 20, and two additional actuating members 22. Similarly, as seen in FIGS. 56-59 a electrical connector 10D for connecting the electrical conductors 11 of four electrical wires 11′ can be created by modifying the connector 10A to include two additional ports 12, two additional spring contacts units 20, and two additional actuating members 22. Those skilled in the art will understand that electrical connectors 10 for connecting the electrical conductors 11 of more than five electrical wires can be created in a similar fashion as the connectors 10C and 10D.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the electrical connector 10 are shown in the figures, it should be understood that this disclosure anticipates variations in the specific details of each of the disclosed components and features of the electrical connector 10 and that no limitation to a specific form, configuration, or detail is intended unless expressly and specifically recited in an appended claim.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. An electrical connector for electrically connecting a pair of conductors, the electrical connector comprising:
a. housing made of an electrical insulating material, the housing having a pair of conductor insertion openings, each of the insertion openings configured to allow one of the pair of conductors to be inserted into the housing;
b. a pair of spring contact units mounted within the housing, each of the spring contact units located relative to a corresponding one of the insertion openings to engage one of the pair of conductors inserted through the one of the insertion openings, each of the spring contact units comprising:
i. a contact surface,
ii. an opposite surface spaced from the contact surface,
iii. a connecting surface extending between the contact surface and the opposite surface, and
iv. a cantilevered contact arm extending between the pair of surfaces to clamp a conductor against one of the pair of surfaces, the contact arm having a contact portion to engage a conductor inserted between the contact portion and the contact surface, the contact arm movable between an initial position wherein a conductor of a predetermined size cannot be freely inserted between the contact portion and the contact surface and an inserting position wherein the conductor of a predetermined size can be freely inserted between the contact portion and the contact surface, the contact arm being spring biased to the initial position;
c. a pair of actuating member, each of the actuating members mounted in a corresponding one of the spring contact units to actuate the contact arm from the initial position to the inserting position as the actuating member is moved from a closed position to an open position, each of the actuating members comprising:
i. an arm engagement surface engaged with the contact arm to transmit an actuation force to the contact arm to move the contact arm from the initial position to the inserting position as the actuating member is moved from the closed position to the open position,
ii. a first guide surface slidably engaged with the contact surface and the connecting surface to assist in guiding the actuating member to translate and rotate as the actuating member moves between the closed and open positions,
iii. a second guide surface slidably engage with the opposite surface to assist in guiding the actuating member to translate and rotate as the actuating member moves between the closed and open positions, and
iv. a user lever fixed to the arm contact, first guide surface, and second guide surface to transmit the actuation force from a user to the contact arm as a user moves the actuating member from the closed position to the open position.

2. The electrical connector of claim 1 wherein:
a. the contact surfaces are defined by a busbar component mounted in the housing between the insertion openings;
b. the opposite surfaces and the connecting surfaces are defined by a u-shaped component having a connecting spine extending perpendicular to the busbar component and a pair of legs extending from the connecting spine on opposite sides of the busbar component from each other;
c. each of the contact arms arm extends from a corresponding one of the pair of legs, with the contact portions abutted against the corresponding contact surface of the busbar with the contact arm in the initial position.

3. The electrical connector of claim 2 wherein the u-shaped component and the contact arms are all made of an electrically conductive material.

4. The electrical connector of claim 1 wherein:
a. each of the first guide surfaces comprises a first curved surface and a first flat surface;
b. each of the second guide surfaces comprises a second curved surface;
c. each of the arm engagement surfaces comprises a third curved surface that extends from a corresponding one of the first curved surfaces.

5. The electrical connector of claim 1 wherein the first and second guide surfaces of each actuating member are configured to resist movement of the actuating member from the open position via engagement with the contact surface and opposite surface.

6. The electrical connector of claim 1 wherein the spring unit is made of electrically conductive material.

7. An electrical connector for electrically connecting a pair of conductors, the electrical connector comprising:
a. housing made of an electrical insulating material, the housing having a pair of conductor insertion openings, each of the insertion openings configured to allow one of the pair of conductors to be inserted into the housing;
b. a busbar component mounted in the housing between the insertion openings;
c. a pair of cantilevered contact arms, each arm positioned on a side of the busbar opposite from the other contact arm to clamp a conductor against the busbar, each contact arm having a contact portion to engage a conductor inserted between the contact portion and the busbar, the contact arm movable between an initial position wherein a conductor of a predetermined size cannot be freely inserted between the contact portion and the busbar and an inserting position wherein the conductor of a predetermined size can be freely inserted between the contact portion and the busbar, the contact arm being spring biased to the initial position; and
d. a pair of actuating member, each of the actuating members mounted on opposite sides of the busbar to actuate a corresponding one of the contact arms from the initial position to the inserting position as the actuating member is moved from a closed position to an open position.
